(19) United States
(12) Patent Application Publication
(10) Pub. No.: US 2007/0079511 A1
(43) Pub. Date: Apr. 12, 2007

(54) Device for slitting an introducer for a pacemaker lead

(75) Inventor: Thomas P. Osypka, Palm Harbor, FL (US)

Correspondence Address: EDWARDS & ANGELL, LLP, P.O. BOX 55874, BOSTON, MA, 02205, US

(73) Assignee: Oscor Inc., Palm Harbor, FL (US)

(21) Appl. No.: 11/544,881

(22) Filed: Oct. 6, 2006

Related U.S. Application Data
(60) Provisional application No. 60/724,711, filed on Oct. 7, 2005.

(51) Int. Cl. B26B 27/00

(52) U.S. Cl. 30/90.1

(57) ABSTRACT

The invention provides a device for slitting a tubular introducer to liberate the tubular introducer from an elongate object introduced into the body of a patient along an axis. The device includes a substantially rigid blade having a cutting edge aligned with the axis, a substantially rigid elongate guide aligned with the axis and integral with the blade, the elongate guide being adapted and configured to engage an exposed portion of the elongate object extending from within the tubular introducer, and an elongate handle disposed on the blade, the handle being aligned with the axis and being of a different material than the guide. The invention also provides a method of manufacturing a device for slitting a tubular introducer.

### CROSS-REFERENCE TO RELATED APPLICATIONS

This application claims the benefit of priority from U.S. Provisional Patent Application Ser. No. 60/724,711, filed Oct. 7, 2005, the disclosure of which is incorporated by reference herein in its entirety.

### BACKGROUND OF THE INVENTION

1. Field of the Invention

The present invention is directed to a device for slitting a tubular introducer from an elongate object introduced into the body of a patient. Particularly, the present invention relates to a device for slitting a tubular introducer, wherein the device has a rigid guide.

2. Description of Related Art

A variety of slitting devices are known in the art for slitting and removing introducers from pacemaker leads, catheters, and other elongate objects after surgical introduction into a patient's body. Of such devices, many are directed to slitting and removing unweakened introducers from pacemaker leads.

The article “Permanente Herzschrittmacherversorgung mittels perkutaner Implantationstechnik” on pages 489-494 of the German-language publication entitled “Herz/Kreislauf 10” (Nov. 10, 1978) describes an apparatus which employs a syringe with a hollow metallic needle serving for introduction of a guide wire into a selected vein (e.g., into the subclavian vein) so that the guide wire can facilitate the insertion of a plastic sleeve- or hose-like introducer with assistance from a rigid dilator. Once a portion of the introducer is properly inserted into the vein or cavity, the guide wire and the dilator are extracted so that the introducer provides an unobstructed passage for implantation of a pacemaker lead, a catheter or a similar elongated object which is to be permanently or temporarily implanted in the body. In a final step, the introducer is severed longitudinally so as to permit its separation from the implanted object. The guide wire is normally a so-called Seldinger spiral, which is caused to pass through the hollow needle of the syringe as soon as the tip of the needle has penetrated into the selected vein and as soon as the cylinder and piston of the syringe are detached from the needle. The convolutions of the Seldinger wire allow for convenient introduction of the front end portion of the introducer and of the hollow cylindrical dilator therein into the vein by rotating the dilator and the introducer around the wire. The guide wire and the dilator are thereupon withdrawn from the vein and from the introducer while the corresponding part of the body can be monitored by an X-ray machine.

Extraction of the introducer upon completed implantation of a pacemaker lead, for example, and its separation from the implanted object present problems because the exposed proximal end of the implanted pacemaker lead carries a plug by means of which the lead is connectable to a pacemaker. The dimensions of the plug (as measured radially of the lead) exceed the inner diameter of the introducer so that the latter cannot be slipped over the plug. Consequently, the introducer must be severed longitudinally and/or otherwise in order to allow for its separation from the implanted lead without the need to remove the plug or to attach the plug to the lead upon completed implantation into the body of the patient. The aforementioned German-language publication offers two solutions, namely to separate the plug from the implanted lead or to use shears or a similar cutting implement in order to slit the introducer longitudinally so as to allow for its separation by moving it radially of and away from the exposed section of the implanted lead.

U.S. Pat. Nos. 4,243,050 and 4,345,606 to Littleford propose to employ a tubular introducer which is formed with a longitudinally extending slot prior to putting it to actual use. This reduces the problem of separating the introducer from the exposed section of the implanted lead without removing the plug but such types of preslotted sleeve-like introducers present many other equally serious or even graver problems. The introducer should exhibit at least some flexibility so that it can conform to the anatomy of a patient in the region where a portion thereof is introduced into the body for the purpose of establishing a path for implantation of a pacemaker lead or the like. The longitudinally extending slot weakens the introducer so that the latter is likely to exhibit excessive flexibility and to actually buckle prior to or during implantation of a lead or the like. This necessitates extraction of the introducer and restarting of the entire procedure, i.e., puncturing of the vein with the needle of a syringe, insertion of a guide wire, insertion of an introducer and a dilator, and extraction of the dilator and guide wire upon completed insertion of the front end portion of the introducer into the vein. On the other hand, if the preslotted introducer is relatively stiff so that it cannot undergo excessive flexing in spite of the longitudinally extending slot therein, the material of the introducer is likely to damage the relatively soft layer of insulating material that surrounds the pacemaker lead. In other words, the rigidity of the introducer cannot be increased at will because an excessively rigid introducer is not likely to assume an optimum shape for implantation of a lead or the like, and such rigid introducer is likely to damage the implanted object as a result of contact between the edges bounding its slit and the insulating material on the lead.

U.S. Pat. No. 4,243,050 to Littleford also discloses an introducer having two tubes that are partially telescoped into each other. The outer tube is weakened by lengthwise slotting, perforation, or other similar means. When the inner tube is completely withdrawn from the outer tube, the outer tube can be separated from the exposed section of a pacemaker lead because its longitudinally extending slot has or can have a width at least matching the diameter of the lead. The approach just discussed exhibits the drawback that the introducer is quite expensive and complex as well as that a lengthy manipulation is necessary to separate its components from the implanted object. Furthermore, large quantities of body fluid can escape by way of the introducer during separation of its components from the exposed section of the lead. Moreover, if the slot is too narrow, the person in charge must use shears, a scalpel or another severing implement to separate the component from the implanted object. The shears and scalpel are likely to damage the insulation on the implanted lead.

Other varieties of preweakened introducers have also been used with results similar to those discussed above. Ultimately, it is desirable to have the introducer unweakened as long as there is convenient means of removing it.

It is well known to use a slitting device to cut a longitudinal slit in unweakened tubular introducers with a sharpened blade. Such slitting devices are taught in U.S. Pat. No. 4,997,424 to Little, U.S. Pat. No. 4,687,469 to Osypka, and U.S. Pat. No. 6,497,681 to Brenner, for example. The devices in these references each have a handle that includes a guide integrally formed into the handle. The guide connects to a catheter or pacemaker lead. These devices also each have a cutting blade disposed in the handle so that when the guide is connected to the catheter or pacemaker lead the device can slit the introducer as the introducer is moved relative to the devices. Generally the handle and guide are formed of an integral piece of plastic or similar material. There are disadvantages in having the guide formed integrally with the plastic handle. The guide must be thin in order to separate an introducer from a catheter or pacemaker lead. Therefore, if the handle is made of inexpensive, flexible plastic, the guide will be all the more flexible and therefore weak. This can lead to frequent failures of such devices during surgery. On the other hand, if the thin guide is to be rigid to avoid such failures, then the entire handle must also be made of a rigid material like high performance plastic, which tends to be more costly.

Such conventional methods and systems have generally been considered satisfactory for their intended purpose. However, the conventional methods also have the drawbacks mentioned above. Although many solutions to the difficulties of removing introducers have been explored, as described above, there still remains a continued need in the art for a device that can reliably slit and remove introducers from catheters, pacemaker leads, and other elongate objects introduced into the bodies of patients. There also remains a need in the art for a reliable slitter that is inexpensive and easy to make and use. The present invention provides a solution for these problems.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied herein and broadly described, the invention includes a device for slitting a tubular introducer to liberate the tubular introducer from an elongate object introduced into the body of a patient along an axis. The device includes a substantially rigid blade having a cutting edge aligned with the axis. The device further includes a substantially rigid elongate guide aligned with the axis and integral with the blade. The elongate guide is adapted and configured to engage an exposed portion of the elongate object extending from within the tubular introducer. The device also includes an elongate handle disposed on the blade. The handle is aligned with the axis and is of a different material than the guide.

In accordance with a further aspect of the invention, the elongate guide can be configured to liberate the introducer from the elongate object by engaging the elongate object while aligning the introducer with the cutting blade.

In accordance with another aspect of the invention, the elongate object can be selected from a group including a pacemaker lead and a catheter.

In accordance with still another aspect of the invention, a device as described herein may be provided including a guide composed of a material selected from the group including metal and plastic. In accordance with one embodiment of the invention, the guide can be composed of a material selected from the group consisting of nitinol, stainless steel, and polyetheretherketones (PEEK), PTFE and titanium.

In accordance with another aspect of the invention, the blade and guide can be composed of substantially the same material. This material may be metal or plastic. If desired, the elongate guide can be laser welded to an exposed end of the cutting blade. In accordance with a preferred embodiment of the invention, a first end of the elongate guide can be chamfered to facilitate liberation of the tubular introducer from the elongate object. If desired, the cutting edge can be oriented at an oblique angle with respect to the axis.

In accordance with still another aspect of the invention, the guide can include a body defining a longitudinally extending slot sized and configured to fit onto and partially surround the exposed portion of the elongate object. In a further aspect in accord with the invention, the slot can have a substantially C-shaped cross-section. In a further aspect in accord with the invention, the slot can have a substantially U-shaped cross-section.

The invention also includes a method for manufacturing a device for slitting a tubular introducer to liberate the tubular introducer from an elongate object introduced into the body of a patient along an axis. The method includes forming an elongate guide from a first substantially rigid material, the elongate guide being configured to engage an exposed portion of the elongate object extending from within the tubular introducer along the axis. The method further includes providing a blade made from a second material, aligning a cutting edge of the blade with the axis, joining the elongate guide to an end of the blade, and overmolding a third material different from the first material onto the cutting blade to form an elongate handle.

In further accordance with the invention, the first material can be selected from the group including nitinol, stainless steel, and plastic. The first material and second material can be substantially the same. If desired, the first material and second material can be the same material. In accordance with a preferred embodiment of the invention, the joining step may include laser welding the elongate guide to the blade.

In accordance with another aspect of the invention, the elongate guide can be formed to include a longitudinally extending slot sized and configured to fit onto and partially surround the exposed portion of the elongate object. If desired, the slot can have a cross-section that is selected from the group including C-shaped and U-shaped.

In accordance with a further aspect of the invention, the method can further include the step of chamfering a first edge of the elongate guide to facilitate engagement between the first edge and a tubular introducer to be slit.

In accordance with still another aspect of the invention, the joining step can include orienting the elongate guide with an end of the cutting blade at an oblique angle with respect to the axis.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a side view of a first representative embodiment of a device for slitting a tubular introducer in accordance with the present invention.

FIG. 2 is an enlarged view of a portion of the device shown in FIG. 1, showing the chamfered edge of the elongate guide, as well as the cutting edge of the blade.

FIG. 3 is a front end view of the device shown in FIG. 1, showing the relationship between the handle and the guide.

FIG. 4 is an enlarged view of a portion of the device shown in FIG. 3 showing in detail the relationship between the guide, the blade, and the handle.

FIG. 5 is a back end view of the device shown in FIG. 1, showing the blade within the handle and the indentations for gripping the handle with one's fingers.

FIG. 6 is a perspective view of a syringe whose hollow needle is in the process of being inserted into the subclavian vein of a patient;

FIG. 7 is an enlarged elevational view of the needle and the sectional view of the vein, showing the tip of the needle in the vein of a patient, as shown in FIG. 6.

FIG. 8 illustrates the structure of FIG. 7 and a portion of a guide wire that extends through and beyond both ends of the needle.

FIG. 9 illustrates the structure of FIG. 8, with the needle shown in a position immediately upon extraction of its tip from the vein.

FIG. 10 shows the vein and the guide wire of FIG. 9 as well as a sleeve-like introducer whose first end portion is already introduced into the vein and which confines the major portion of a cylindrical dilator while the latter surrounds the guide wire.

FIG. 11 shows the structure of FIG. 10 with the dilator and guide wire in the process of being extracted from the introducer.

FIG. 12 illustrates the vein and the introducer of FIG. 11 and the leading end of a pacemaker lead, which is about to enter the exposed second end portion of the introducer.

FIG. 13 shows the structure of FIG. 12, with the lead fully inserted.

FIG. 14 shows the structure of FIG. 13 with the handgrip portions at the exposed end of the introducer moved partly toward each other.

FIG. 15 shows the introducer of FIG. 14, with the introducer extracted from the vein, and with the flat edge faces of the two handgrip portions in abutment with one another to facilitate extraction of the first end portion of the introducer from the vein and severing of the introducer in the course of and subsequent to the extracting step by the device for slitting of FIG. 1.

FIG. 16 is a perspective view of the device shown in FIG. 1, showing the slot in the grip indentation for facilitating gripping of the lead during the course of severing the introducer.

FIG. 17 is a perspective view of a tubular introducer, showing the handles in opposition to each other as well as the end of the introducer where slitting commences.

FIG. 18 shows the device for slitting of FIG. 1 with the lead running through the guide and through the slot in the handle.

FIG. 19 shows the device for slitting of FIG. 1 immediately prior to severing the tubular introducer, with the lead pressed between a finger and the slot in the grip indentation of the device for slitting.

FIG. 20 shows the device for slitting of FIG. 1 during severing of a second type of tubular introducer, with the tubular introducer moving past the device and with the lead held tightly in place between a finger and the device.

### DETAILED DESCRIPTION OF THE PREFERRED EMBODIMENT

Reference will now be made in detail to the present preferred embodiment of the invention, an example of which is illustrated in the accompanying drawings. The method and corresponding steps of the invention will be described in conjunction with the detailed description of the system.

The devices and methods presented herein may be used for liberating tubular introducers from elongate objects introduced into the veins and body cavities of patients. The present invention is particularly suited for liberating unweakened introducers from pacemaker leads.

In accordance with the invention, a device for slitting a tubular introducer to liberate the tubular introducer from an elongate object introduced into the body of a patient along an axis is provided. The device includes a substantially rigid blade having a cutting edge aligned with the axis, a substantially rigid elongate guide aligned with the axis and integral with the blade, the elongate guide being adapted and configured to engage an exposed portion of the elongate object extending from within the tubular introducer, and an elongate handle disposed on the blade, the handle being aligned with the axis and being of a different material than the guide.

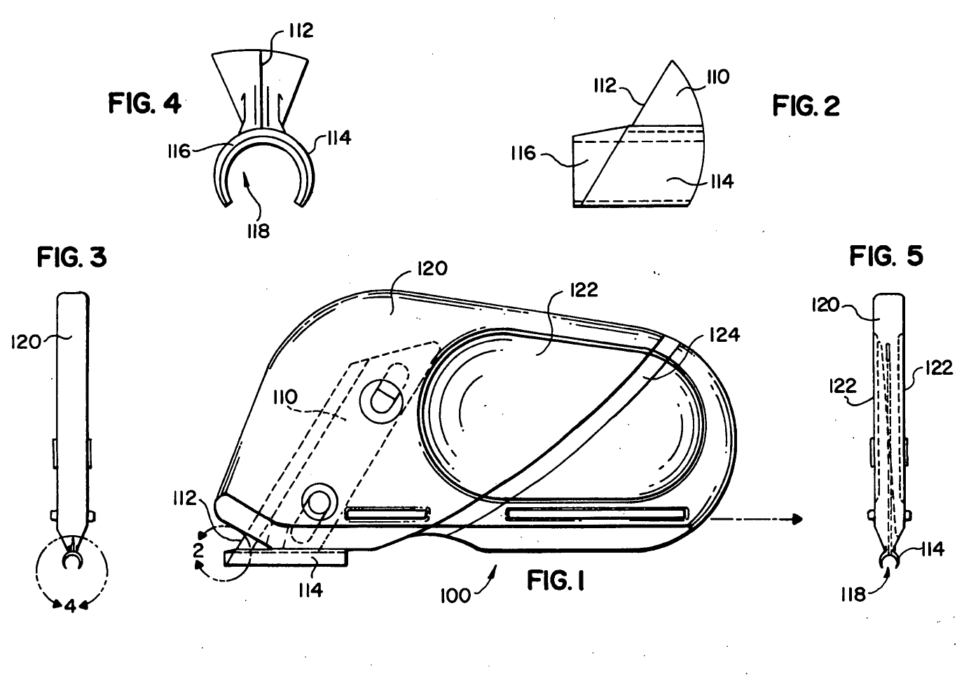

For purpose of explanation and illustration, and not limitation, a partial view of an exemplary embodiment of the device in accordance with the invention is shown in FIG. 1 and is designated generally by reference character 100. Other embodiments of a device for slitting a tubular introducer in accordance with the invention, or aspects thereof, are provided in FIGS. 2-20, as will be described.

As depicted in FIG. 1, device 100 is provided with a substantially rigid blade 110. The cutting edge 112 of the blade 110 is generally aligned within a radial plane of an axis defined by a tubular introducer and accompanying catheter, pacemaker lead or other elongate object during use of the device 100, as described in detail below. It is contemplated that the cutting edge 112 also be angled with respect to the axis. The angle can be any angle, including right angles, but preferably the cutting edge 112 is arranged at an oblique angle with respect to the axis. Having this oblique angle makes the process of slitting the tubular introducer, as described below, more efficient.

In further accordance with the invention, a substantially rigid elongate guide is provided, the guide being aligned with the axis and being integral with the blade. The guide is adapted and configured to engage an exposed portion of the elongate object extending from within the tubular introducer.

For purposes of illustration and not limitation, as embodied herein and as depicted in FIGS. 1-5, device 100 includes a substantially rigid elongate guide 114. The guide 114 is generally aligned with the axis of the elongate object when the device 100 is in operation, as described below.

The guide 114 is integrally connected to the blade 110. The guide 114 is adapted and configured to engage an exposed portion of the elongate object extending from within the tubular introducer. Preferably, the guide 114 is configured to liberate the introducer from the elongate object by engaging the elongate object while aligning the introducer with the cutting blade.

The guide 114 can include a body defining a longitudinally extending slot 118 sized and configured to fit onto and partially surround the exposed portion of the elongate object. The slot 118 can be substantially C-shaped in its cross section. The shape of the cross-section of the slot 118 can also be substantially U-shaped, or any other suitable shape. The slot is preferably dimensioned to fit tightly enough around the elongate object to grip and prevent movement along the axis of the elongate object, while being loose enough to avoid damaging the elongate object. It is of particular import to avoid damaging the relatively soft insulation surrounding pacemaker leads, for example.

The guide 114 can be chamfered on one end, particularly the end facing the same direction as the cutting edge 112. The chamfer 116 allows the guide 114 to more easily be worked in between the tubular introducer and the elongate object. With the guide 114 tightly situated between the elongate object and the tubular introducer, the cutting edge 112 is aligned to slit the tubular introducer.

A variety of materials can be used to form the guide 114. In order to overcome the problems with conventional slitting devices, the material is preferably rigid. Also, the material is preferably inexpensive in general, and in particular, the material should be inexpensive to machine and join to the blade 110. The material is preferably a metal or plastic such as nitinol, stainless steel, or polyetheretherketones.

In accordance with a further aspect of the invention, the guide 114 and the blade 110 can be composed of substantially the same material. They can both be formed of metal. They can also both be formed of plastic.

The guide 114 and blade 110 can be joined by any conventional joining process, as is known in the art. Laser welding can be used to give the joint between the blade 110 and the guide 114 the desired strength and rigidity needed for reliable slitting of tubular introducers with minimal breakage. Preferably, if laser welding is used to join the blade 110 and guide 114, the materials of the blade 110 and guide 114 are chosen for weldability.

In further accordance with the invention, the device includes an elongate handle disposed on the blade. The handle is aligned with the axis and is made of a different material than the guide.

For purposes of illustration only, as depicted in FIGS. 1-5, device 100 includes an elongate handle 120. The handle 120 is disposed on the blade 110 and is generally aligned with the axis “X” of the elongate object (see, e.g. FIG. 15). The material of handle 120 is different from the material used to form the guide 114. The handle 120 does not necessarily need the same degree of rigidity as the guide 114, hence less expensive materials can be used in forming the handle 120. Preferably, the handle 120 is fabricated from an inexpensive plastic that can readily overmold the blade 110. In this manner, the handle 120 can almost completely surround the blade 110, leaving only a small portion of cutting edge 112 exposed. In this way, there is enough of cutting edge 112 exposed to sever the tubular introducer, but not enough to pose a significant risk of cutting anything else such as the elongate object or a user's fingers.

The handle 120 can include further features that facilitate the use of the device 100. One example is the grips 122 that are preferably included in the sides of handle 120. The grips 122 can be sized and shaped to increase the gripping ability by fingers of users of the device 100. Further, a channel 124 can be provided extending across the surface of the handle 120. The channel 124 is preferably sized to accommodate a portion of the elongate body. The channel 124 can define an arc extending generally from the end of the guide 114 opposite the cutting edge 112, across the grip 122, and out the upper rear portion of the handle 120. The shape and size of channel 124 can thus accommodate a portion of the elongate object without undue bending or kinking of the elongate object.

The device 100 has superior properties for removing tubular introducers from elongate objects introduced into the bodies of patients, and in particular human patients. The device 100 can be used to remove tubular introducers from a wide variety of elongate objects, including catheters, among other things, without departing from the spirit and scope of the invention. The following description explains how the device 100 can be used in a typical operation. By way of example and not limitation, the following describes the use of the device 100 to remove a tubular introducer from a pacemaker lead after introduction to the subclavian vein of a human patient.

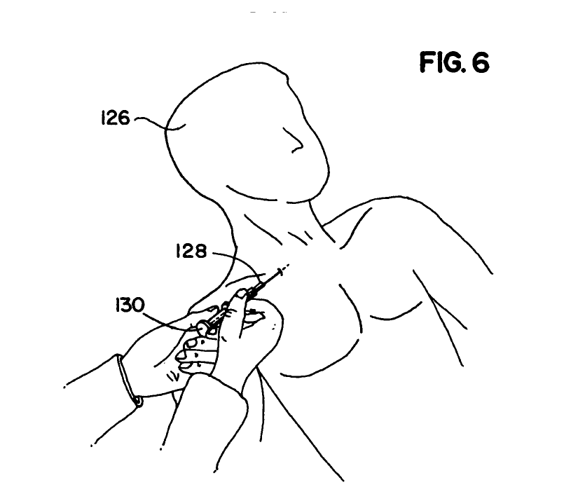

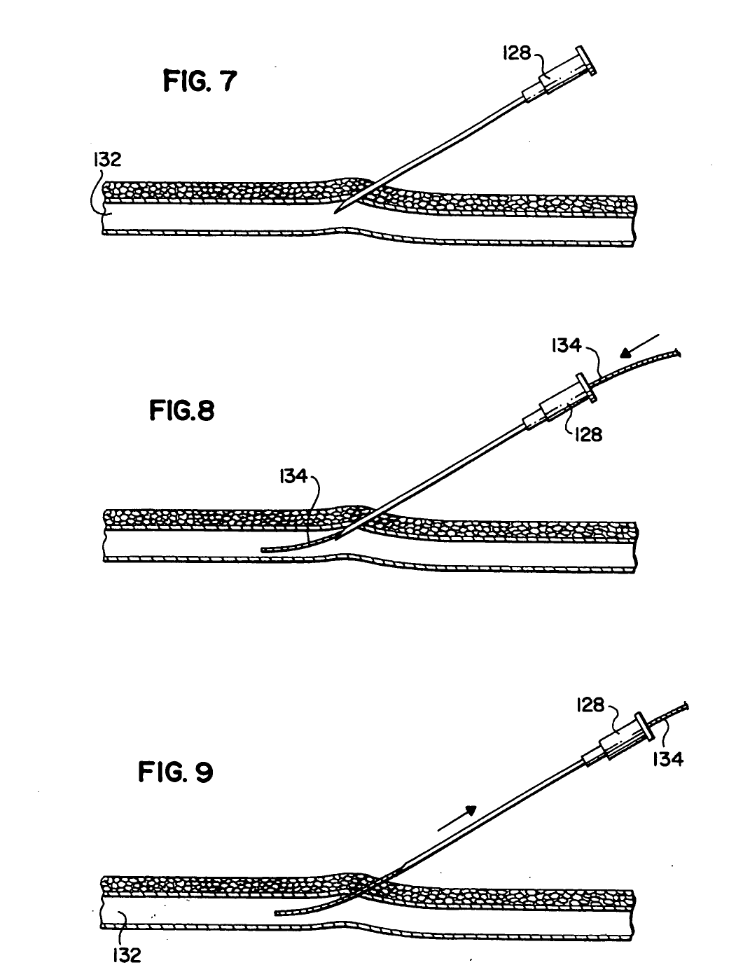

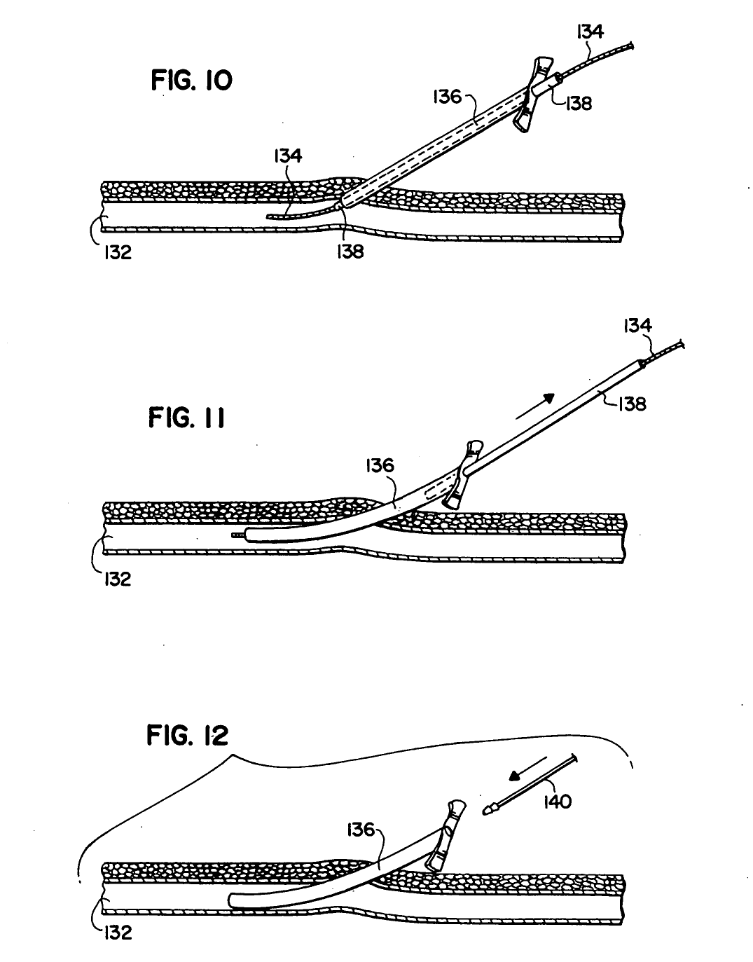

FIG. 6 shows a patient 126 with the metallic needle 128 of a syringe 130 inserted into the subclavian vein 132 (see FIG. 7). As seen in FIG. 7, the syringe 130 can be removed from the needle 128 once the needle has penetrated the vein 132. At this point, a flexible guide wire 134 can be inserted through the needle 128 and into the vein 132, as depicted in FIG. 8. With the guide wire 134 secured within the vein, the needle 128 can be withdrawn from the vein 132 and removed from the guide wire 134, as shown in FIG. 9. Next, and as shown in FIG. 10, a tubular introducer 136 is placed on the wire 134. From here, the tubular introducer 136 can be worked along the wire 134 until one end penetrates the vein 132. The tubular dilator 138 disposed between the wire 134 and the tubular introducer 136 facilitates vein penetration by the tubular introducer 136 by preventing buckling of the tubular introducer 136 as it is urged into the vein 132. Once an end of the tubular introducer 136 is in the vein, the dilator 138 and the wire 134 can be withdrawn from the tubular introducer 136 without removing the end of the tubular introducer 136 from within the vein 132, as depicted in FIG. 11.

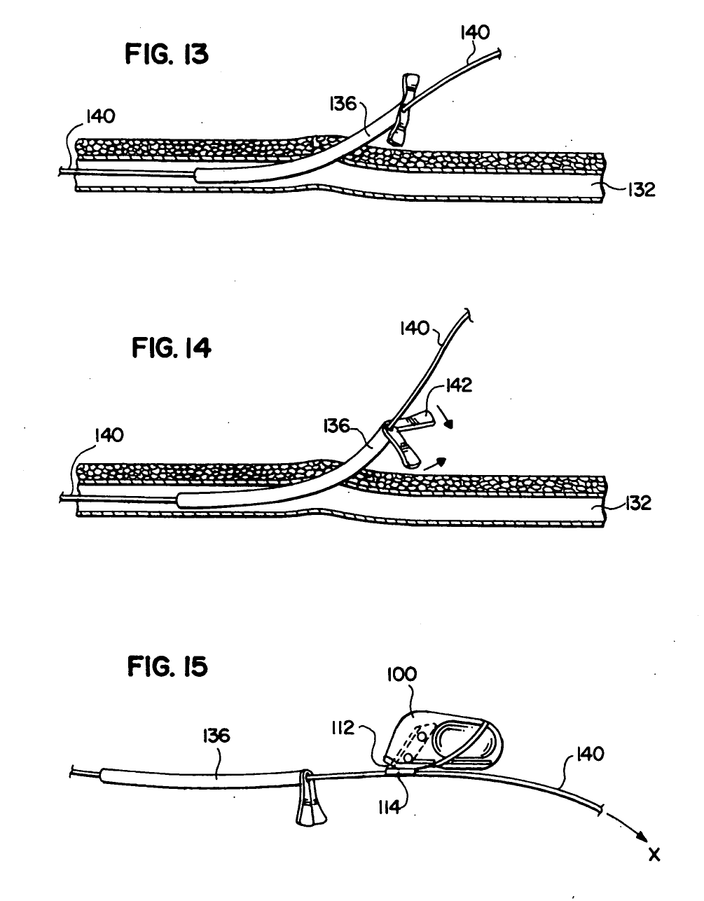

FIG. 12 shows the empty tubular introducer 136 with one end securely inside the subclavian vein 132. In this configuration, the tubular introducer 136 is finally ready to introduce an elongate object, such as pacemaker lead 140, into the vein 132. FIG. 13 shows the pacemaker lead 140 fully introduced into the vein 132.

Once the pacemaker lead 140 is fully introduced into the vein 132, the tubular introducer 136 has served its purpose and it must therefore be removed from the vein 132. FIG. 14 shows a tubular introducer 136 with rotatable handles 142. Other configurations of handles 142 are also possible, however. The rotatable handles 142 shown in FIG. 14 facilitate removal of the tubular introducer 136 by providing a sturdy place to grip the tubular introducer 136.

Since pacemaker lead 140, for example, often has a plug on one end that is too big to pass through the tubular introducer 136, the tubular introducer 136 must be severed in order to be removed from the pacemaker lead 140 at this stage. It is for this purpose that the device 100 is particularly well suited.

FIG. 15 shows the device 100 connected to the lead 140. At this stage, the tubular introducer 136 can still be partially within the vein 132, or can be completely removed from the vein 132 as shown in FIG. 15. The guide 114 is configured, as described in detail above, to engage the lead 140 and position the cutting edge 112 so that the tubular introducer 136 will be severed on contact with the cutting edge 112.

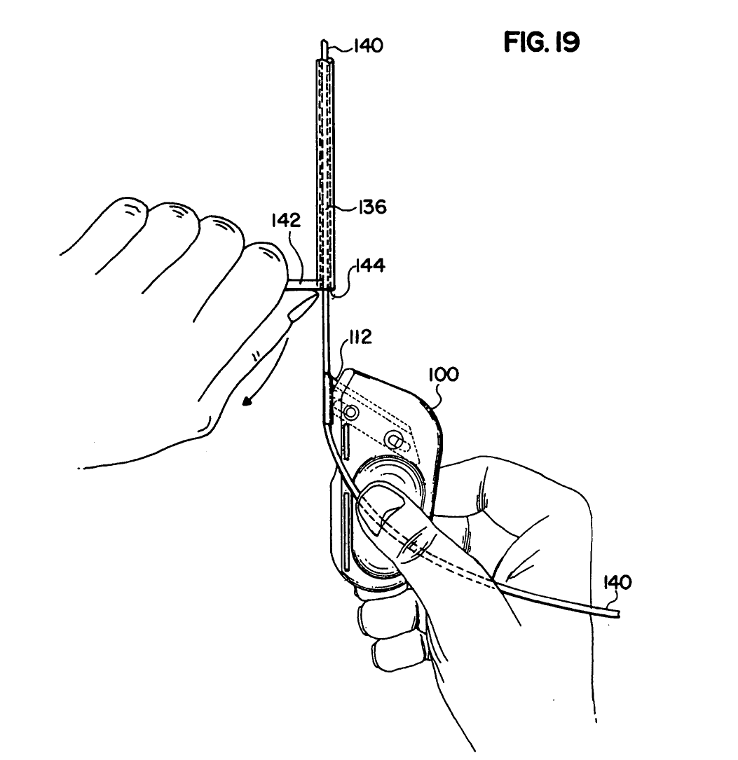

At this stage the person using the device 100 can pinch the lead 140 between a finger or thumb and the handle 120. It is advantageous to pinch a portion of lead 140 into the channel 124, depicted in FIGS. 16 and 18, to gain a tight grip on the lead 140 with minimal exertion. With the lead 140 tightly gripped by the guide 114 and the channel 124, the lead 140 is less prone to motion in the longitudinal direction when the tubular introducer 136 is being slit.

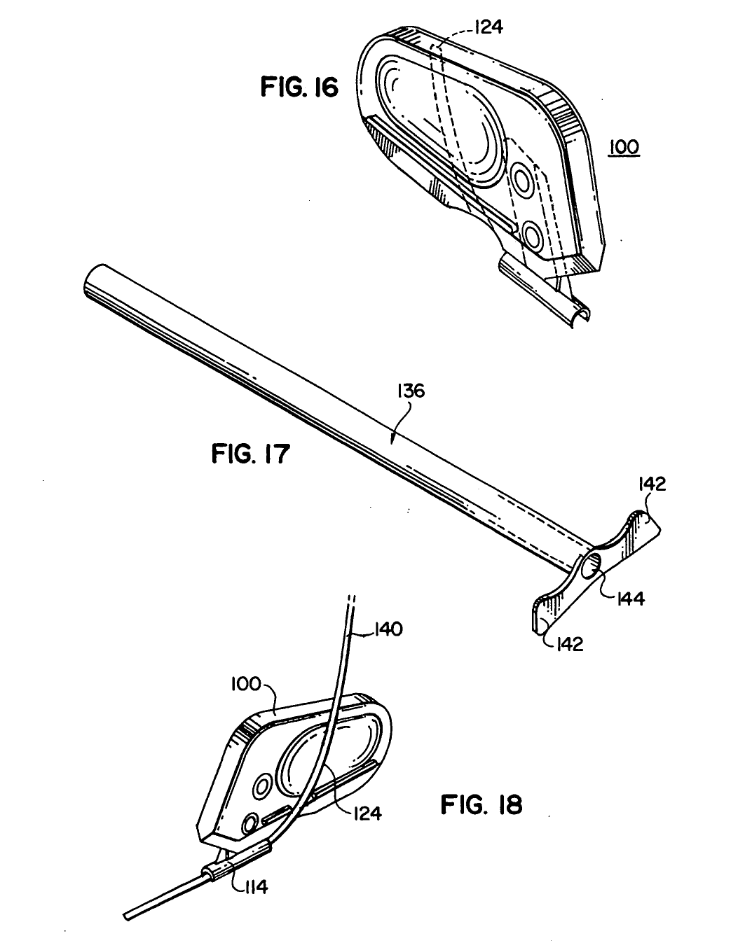

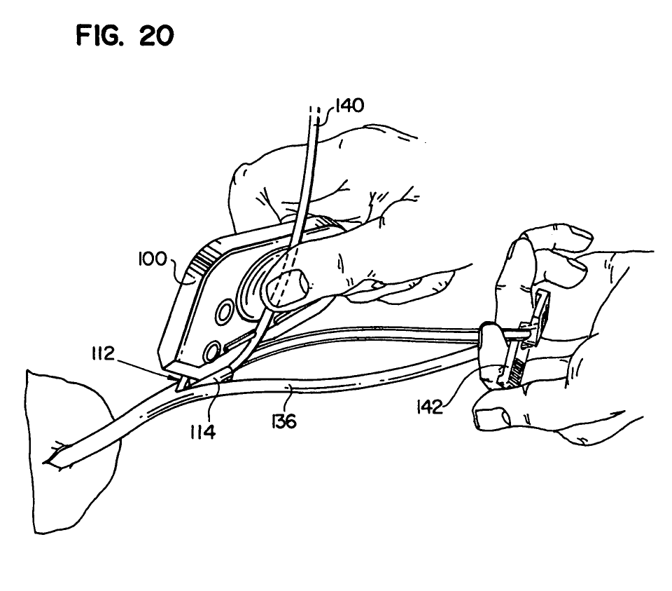

FIG. 17 shows the end 144 of the tubular introducer 136 where the slitting commences. It is possible to prepare the tubular introducer 136 for slitting by rotating the rotating handles 142 into alignment with each other to form a sturdy grip for pulling, as seen in FIG. 19. Another way or preparing the tubular introducer 136 for slitting is to tear the end 144 of the tubular introducer 136 by pulling the hand handles 142 away from each other. This can create two tears in the tubular introducer 136, one of which will be slit all the way along the length of tubular introducer 136 by the device 100 (see FIG. 20).

FIG. 19 shows the device 100 in use immediately prior to slitting the tubular introducer 136. A person can firmly restrain the lead 140 from movement in the axial direction, as described above, with one hand. The other hand is free to grip the introducer handles 142 and pull the tubular introducer 136 into the cutting edge 112 of the device 100. FIG. 20 shows a tubular introducer 136 of the type where the handles 142 are torn from each other rather than rotated. FIG. 20 further shows how the guide 114 forces a tubular introducer 136 into the cutting edge 112 and off from the lead 140 as a person pulls the tubular introducer 136 past the device 100. The tubular introducer 136 is fully removed once it has been pulled past the device 100 entirely.

While the device 100 can be configured and adapted especially for the removal of introducers from pacemaker leads as described above, those of ordinary skill in the art will readily appreciate how to practice the invention in similar configurations for the removal of tubular introducers from other elongate objects without departing from the spirit and scope of the invention. Further, the use of various different kinds of introducers, as in the two different varieties seen in FIG. 19 and FIG. 20, as well as other tubular introducers known to those of ordinary skill in the art, are not beyond the spirit and scope of the invention.

In accordance with another aspect of the invention, a method is provided for manufacturing a device for slitting a tubular introducer to liberate the tubular introducer from an elongate object introduced into the body of a patient along an axis. The method includes the step of forming an elongate guide from a first substantially rigid material, the elongate guide being configured to engage an exposed portion of the elongate object extending from within the tubular introducer along the axis. The method further includes the steps of providing a blade made from a second material, aligning a cutting edge of the blade with the axis, joining the elongate guide to an end of the blade, and overmolding a third material different from the first material onto the cutting blade to form an elongate handle.

For purposes of illustration and not limitation, as embodied herein, a method is provided for manufacturing a device (e.g. 100) for slitting a tubular introducer (e.g. 136). An elongate guide (e.g. 114) is formed from a first substantially rigid material. The elongate guide, as described in detail above, is configured and adapted to engage an exposed portion of an elongate object (e.g. 140) extending from within a tubular introducer along the axis. Preferably, the guide is formed to include a longitudinally extending slot (e.g. 118) sized and configured to fit onto and partially surround the exposed portion of the elongate object. A blade (e.g. 110) is also provided, the blade being made from a second material. The cutting edge (e.g. 112) of the blade is aligned with the axis. Preferably the cutting edge is aligned in a radial plane of the axis. The elongate guide is joined to one end of the blade. Finally a third material that is different from the first material is overmolded onto the cutting blade to form an elongate handle (e.g. 120).

In further accordance with the invention, the method can include the further step of chamfering a first edge of the elongate guide to facilitate engagement between the first edge and a tubular introducer to be slit in the manner described above.

In accordance with another aspect of the invention, the step of joining can further include orienting the elongate guide with an end of the cutting blade at an oblique angle with respect to the axis. The cutting edge can thus be aligned in a radial plain of the axis while also being at an oblique angle with the axis itself.

In further accordance with the method of the invention, it is also possible to join the elongate guide to the cutting blade by laser welding.

The methods and systems of the present invention, as described above and shown in the drawings, provide for a device for slitting a tubular introducer. The device has superior properties including ease of use, inexpensive cost, and reliability. It will be apparent to those skilled in the art that various modifications and variations can be made in the device and method of the present invention without departing from the spirit or scope of the invention. Thus, it is intended that the present invention include modifications and variation that are within the scope of the appended claims and their equivalents.

What is claimed is:

1. A device for slitting a tubular introducer to liberate the tubular introducer from an elongate object introduced into the body of a patient along an axis, the device comprising:
a. a substantially rigid blade having a cutting edge aligned with the axis;
b. a substantially rigid elongate guide aligned with the axis and integral with the blade, the elongate guide being adapted and configured to engage an exposed portion of the elongate object extending from within the tubular introducer; and
c. an elongate handle disposed on the blade, the handle being aligned with the axis and being of a different material than the guide.

2. A device for slitting a tubular introducer as recited in claim 1, wherein the elongate guide is configured to liberate the introducer from the elongate object by engaging the elongate object while aligning the introducer with the cutting blade.

3. A device for slitting a tubular introducer as recited in claim 1, wherein the elongate object is selected from the group consisting of a pacemaker lead and a catheter.

4. A device for slitting a tubular introducer as recited in claim 1, wherein the guide is composed of a material selected from the group consisting of metal and plastic.

5. A device for slitting a tubular introducer as recited in claim 4, wherein the guide is composed of a material selected from the group consisting of nitinol, stainless steel, polyetheretherketones, PTFE and titanium.

6. A device for slitting a tubular introducer as recited in claim 1, wherein the blade and guide are composed of substantially the same material.

7. A device for slitting a tubular introducer as recited in claim 6, wherein the material is selected from the group consisting of a metal and a plastic.

8. A device for slitting a tubular introducer as recited in claim 1, wherein the elongate guide is laser welded to an exposed end of the cutting blade.

9. A device for slitting a tubular introducer as recited in claim 1, wherein a first end of the elongate guide is chamfered to facilitate liberation of the tubular introducer from the elongate object.

10. A device for slitting a tubular introducer as recited in claim 1, wherein the cutting edge is oriented at an oblique angle with respect to the axis.

11. A device for slitting a tubular introducer as recited in claim 1, wherein the guide includes a body defining a longitudinally extending slot sized and configured to fit onto and partially surround the exposed portion of the elongate object.

12. A device for slitting a tubular introducer as recited in claim 11, wherein the slot has cross-section substantially in a shape selected from the group consisting of C-shaped and U-shaped.

13. A method for manufacturing a device for slitting a tubular introducer to liberate the tubular introducer from an elongate object introduced into the body of a patient along an axis, the method comprising steps of:
a. forming an elongate guide from a first substantially rigid material, the elongate guide being configured to engage an exposed portion of the elongate object extending from within the tubular introducer along the axis;
b. providing a blade made from a second material;
c. aligning a cutting edge of the blade with the axis;
d. joining the elongate guide to an end of the blade; and
e. overmolding a third material different from the first material onto the cutting blade to form an elongate handle.

14. A method as recited in claim 13, wherein the first material is selected from the group consisting of nitinol, stainless steel, and plastic.

15. A method as recited in claim 13, wherein the first material and second material are substantially the same.

16. A method as recited in claim 13, wherein the first material and second material are the same material.

17. A method as recited in claim 13, wherein the step of joining the elongate guide to the cutting blade includes laser welding the elongate guide to the blade.

18. A method as recited in claim 13, wherein the elongate guide is formed to include a longitudinally extending slot sized and configured to fit onto and partially surround the exposed portion of the elongate object.

19. A method as recited in claim 18, wherein the slot has a cross-section substantially in a shape selected from the group consisting of C-shaped and U-shaped.

20. A method as recited in claim 13, further comprising the step of chamfering a first edge of the elongate guide to facilitate engagement between the first edge and a tubular introducer to be slit.

21. A method as recited in claim 13, wherein the joining step includes orienting the elongate guide with an end of the cutting blade at an oblique angle with respect to the axis.
